(19) United States
(12) Patent Application Publication
(10) Pub. No.: US 2020/0395697 A1
(43) Pub. Date: Dec. 17, 2020

(54) CONNECTION TERMINAL FOR PCB BOARDS

(71) Applicant: Xiamen Ghgm Electric Co., Ltd., Xiamen (CN)

(72) Inventor: Bingshui Chen, Xiamen (CN)

(21) Appl. No.: 16/578,518

(22) Filed: Sep. 23, 2019

(30) Foreign Application Priority Data
Jun. 14, 2019 (CN) 201910517302.9

(51) Int. Cl. H01R 12/73; H01R 12/72

(52) U.S. Cl. CPC H01R 12/73; H01R 12/721

(57) ABSTRACT

A connection terminal for PCB boards comprises a female connector assembly and a male connector assembly, wherein the female connector assembly comprises a female connector housing defining a slot and a conductive clip located at the female connector housing and supported at the first PCB board, the male connector assembly can be moved along with the second PCB board to connect the female connector assembly such that the male plug arranged on the male connector housing of the male connector assembly and electrically connected to the second PCB board is disposed at the clamping portion of the conductive clip accommodated in the slot, to enable the electrical connection between two PCB boards; the male connector assembly can be moved along with the second PCB board to be separated from the female connector assembly such that the male plug is separated from the clamping portion and the two boards are disconnected.

### CROSS-REFERENCE TO RELATED APPLICATION

This application claims the priority benefit of Chinese Patent Application No. 201910517302.9, filed on Jun. 14, 2019, which is hereby incorporated by reference in its entirety.

### TECHNICAL FIELD

This disclosure relates to the technical field of connection terminals, and more particularly to a connection terminal for PCB boards.

### BACKGROUND

Some electronic products are provided with a plurality of PCB boards and an electrical connection between such PCB boards is required. In the prior art, PCB boards usually are connected by wires or directly welded together. However, in such case, the PCB boards cannot be detachably connected. Furthermore, the connecting operation of the PCB boards is too complex and a quick electrical connection cannot be realized.

To this end, the inventor studied the prior arts and presents this application.

### SUMMARY

The present disclosure provides a connection terminal for PCB boards, which is intended to solve the problem in the prior art that a detachable connection between the PCB boards.

To this end, the present disclosure provides a connection terminal for PCB boards, which is configured to electrically connect the first PCB board with the second PCB board, wherein the connection terminal comprises:

a female connector assembly comprising a female connector housing defining a slot and comprising a conductive clip located at the female connector housing and supported at the first PCB board, wherein the conductive clip comprises a clamping portion accommodated in the slot and comprises a connecting portion located on the clamping portion and electrically connected to the first PCB board; and

a male connector assembly comprising a male connector housing located on the second PCB board and comprising a male plug arranged on the male connector housing and electrically connected to the second PCB board, wherein the male plug can be engaged with the clamping portion;

wherein the male connector assembly can be moved along with the second PCB board to connect with the female connector assembly in such a manner that the male plug is disposed at the clamping portion to enable the electrical connection between the first PCB board and the second PCB board; and the male connector assembly can be moved along with the second PCB board to be separated from the female connector assembly such that the male plug is separated from the clamping portion and the first PCB board is disconnected from the second PCB board.

Further, the clamping portion may be perpendicular to the connecting portion, the female connector housing may define an accommodating slot in communication with the slot, and the connecting portion may be disposed in the accommodating slot.

Further, the clamping portion may be parallel to the connecting portion, and both the clamping portion and the connecting portion may be disposed in the slot.

Further, the female connector assembly comprises a plurality of conductive clips, and the male connector assembly comprises a plurality of male plugs which respectively correspond to the plurality of conductive clips; the plurality of male plugs are respectively arranged on the male connector housing at increasing or decreasing heights corresponding to the positions of the plurality of conductive clips.

Further, the clamping portion may be formed by a pair of conductive sheets arranged in a ‘U’ like shape or a ‘V’ like shape.

Further, the first PCB board and the second PCB board form an angle in a range of 0°-180°.

Further, the first PCB board and the second PCB board form an angle of 90° or 180°.

Further, the female connector assembly comprises three conductive clips, and the male connector assembly comprises three male plugs which respectively correspond to the three conductive clips.

With the above technical solution, the present disclosure has technical advantages as follows.

The connection terminal provided by the present disclosure enables a detachable connection between two PCB boards. In particular, the connection terminal comprises the female connector assembly arranged on the first PCB board and the male connector assembly arranged on the second PCB board, and the specific connection relationship between the first PCB board and the second PCB board is as follows.

In the case that an electrical connection between the first PCB board and the second PCB board is required, the second PCB board can cause the male connector assembly to be disposed at the female connector assembly in such a manner that the male plug is disposed at the clamping portion to enable the electrical connection between the first PCB board and the second PCB board. In the case that an electrical disconnection between the first PCB board and the second PCB board is required, the second PCB board can cause the male connector assembly to be separated from the female connector assembly such that the male plug is separated from the clamping portion and the first PCB board is disconnected from the second PCB board.

With the above mentioned technical solution, the first PCB board and the second PCB board can be electrically and separately connected by means of the connection terminal of the present disclosure. Meanwhile, the connection terminal further functions to <Not sure what you mean here> retain the first PCB board and the second PCB board, to facilitate the arrangement of the first PCB board and the second PCB board forming the desired angle therebetween. Moreover, by means of the connection terminal of the present disclosure, the first PCB board and the second PCB board can be electrically connected quickly and conveniently operated.

### BRIEF DESCRIPTION OF THE DRAWINGS

In order to describe the technical solution of embodiments of the disclosure more clearly, drawings illustrating the embodiments will be briefly described below. It should be understood that the following drawings merely show certain embodiments of the disclosure and therefore should not be considered to limit the scope of the disclosure. For those skilled in the art, other related drawings may also be obtained based on these drawings without any creative work.

FIG. 1 is a first isometric view of the connection terminal according to the first embodiment of the present disclosure;

FIG. 2 is an exploded view of the connection terminal according to the first embodiment of the present disclosure;

FIG. 3 is a first partially exploded view (in which the male connector housing and the female connector housing are not shown) of the connection terminal according to the first embodiment of the present disclosure;

FIG. 4 is a second isometric view (in which the male connector housing and the female connector housing are not shown) of the connection terminal according to the first embodiment of the present disclosure;

FIG. 5 is a second partially exploded view of the connection terminal according to the first embodiment of the present disclosure;

FIG. 6 is a third partially exploded view of the connection terminal according to the first embodiment of the present disclosure;

FIG. 7 is a first partially exploded view of the connection terminal according to the second embodiment of the present disclosure;

FIG. 8 is a second partially exploded view (in which the male connector housing and the female connector housing are not shown) of the connection terminal according to the second embodiment of the present disclosure;

FIG. 9 is a first isometric view (in which the male connector housing and the female connector housing are not shown) of the connection terminal according to the second embodiment of the present disclosure;

FIG. 10 is a first exploded view of the connection terminal according to the second embodiment of the present disclosure;

FIG. 11 is a second exploded view of the connection terminal according to the second embodiment of the present disclosure;

FIG. 12 is a first isometric view of the connection terminal according to the third embodiment of the present disclosure;

FIG. 13 is a first isometric view (in which the female connector housing is not shown) of the connection terminal according to the third embodiment of the present disclosure;

FIG. 14 is a partially exploded view of the connection terminal according to the third embodiment of the present disclosure;

FIG. 15 is an exploded view of the connection terminal according to the third embodiment of the present disclosure;

FIG. 16 is a partially exploded view of the connection terminal according to the fourth embodiment of the present disclosure.

### DETAILED DESCRIPTION

In order to make the purpose, technical solution and advantages of embodiments of the present disclosure more clear, the embodiments of the present disclosure will be described more completely and clearly below in conjunction with the accompanying drawings illustrating the embodiments. It is apparent that the embodiments described below are merely some, but not all, embodiments of the present disclosure. Based on the embodiments of the present disclosure, those skilled in the art may obtain other embodiments included within the scope of the present disclosure without any creative work. Therefore, the detailed description of embodiments of the present disclosure illustrated in the accompanying drawings is not intended to limit the scope of the disclosure, but rather illustrates particular embodiments of the present disclosure. Based on the embodiments of the present disclosure, those skilled in the art may obtain other embodiments included within the scope of the present disclosure without any creative work.

In the description of the present disclosure, it is to be understood that the orientational or positional relationships indicated by the terms “center”, “longitudinal”, “transversal”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc. are based on the orientation or positional relationship shown in the drawings, are merely for the convenience of describing the present disclosure and simplifying the description, and do not indicate or imply that the device or component referred to must have a specific orientation or be constructed and operated in a specific orientation. Therefore, it should not be construed as limiting the present disclosure.

Moreover, the terms “first” and “second” are used for descriptive purposes only and are not to be construed as indicating or implying relative importance or implicitly indicating the number of technical features indicated. Thus, features defining “first” and “second” may include one or more of the features either explicitly or implicitly. In the description of the present disclosure, the meaning of “a plurality of” is two or more unless specifically defined otherwise.

In the present disclosure, the terms “installation,” “connected,” “attached,” fixed,” and the like shall be interpreted broadly, and, for example, may be fixed, detachable, or integrated, unless otherwise explicitly defined. The term “connection” or “connect” could be a mechanical connection or electrical connection, and may be directly connected or indirectly connected through an intermediate medium. For those skilled in the art, the specific meanings of the above terms in the present disclosure can be conceivable.

In the present disclosure, the first feature “on” or “under” the second feature may include direct contact or indirect contact of the first and second features, unless otherwise specifically defined. Moreover, the first feature “above,” “over,” or “onto” the second feature includes the first feature directly or indirectly above or onto the second feature. The first feature “below,” “under,” or “beneath” the second feature includes the first feature directly or indirectly below or beneath the second feature, or merely the first feature level being less than the second feature.

The disclosure will be further described accompany with the following figures and detailed embodiments.

The present disclosure will be described below in detail with reference to the accompanying drawings and in combination with particular embodiments.

### The First Embodiment

A first PCB board 1 and a second PCB board 2 form an angle therebetween of 90°. The details are as follows.

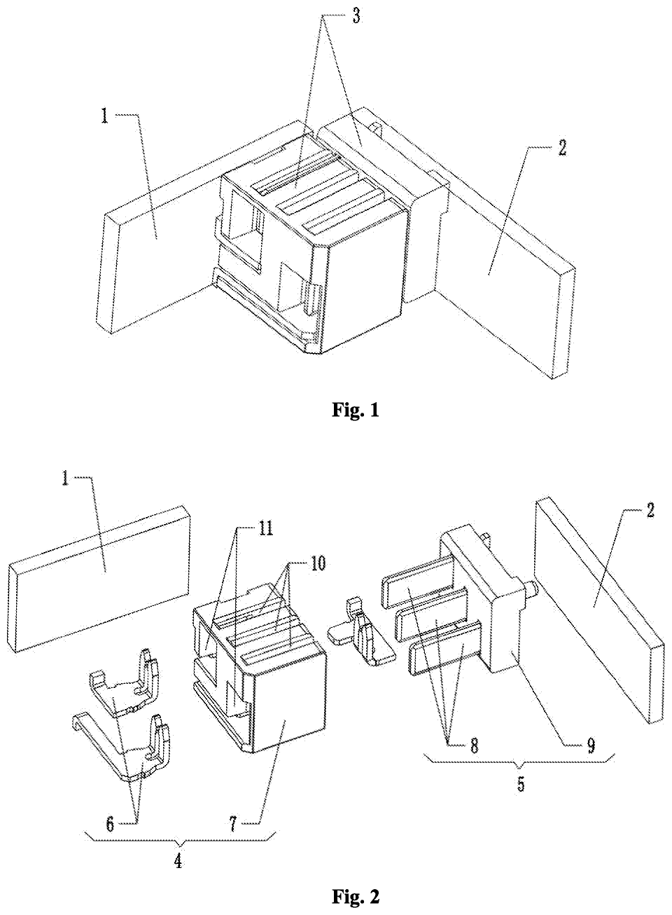

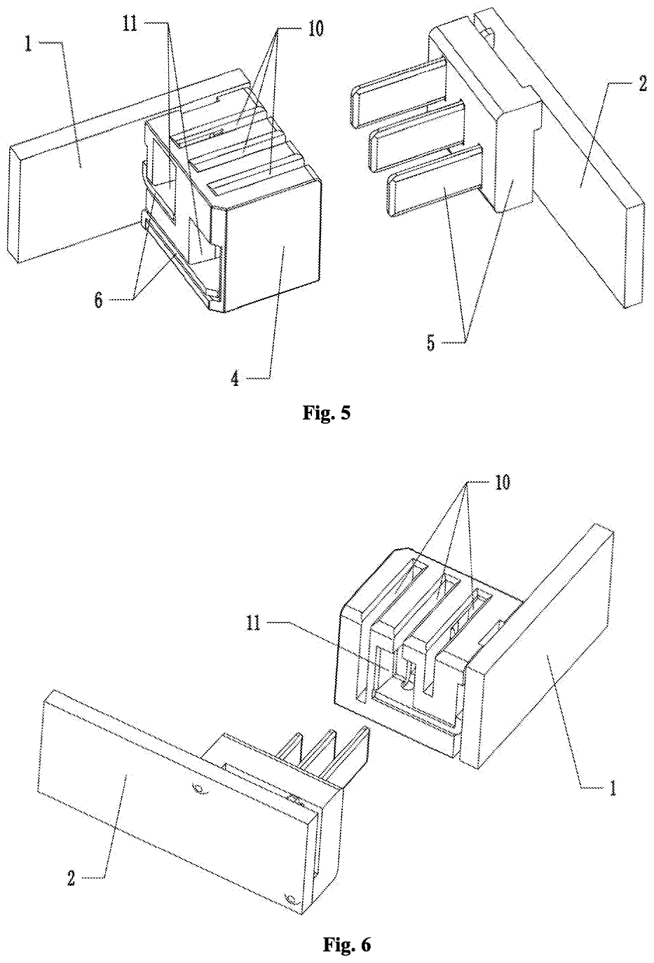

Referring to FIGS. 1-6, a connection terminal for PCB boards in the present embodiment is configured to electrically connect the first PCB board 1 with the second PCB board 2. The connection terminal 3 comprises:

a female connector assembly 4, which comprises a female connector housing 7 defining slots 10 and comprising conductive clips 6 located at the female connector housing 7 and supported at the first PCB board 1, wherein each conductive clip 6 comprises a clamping portion 13 accommodated in respective slot 10 and comprises a connecting portion 12 located on the clamping portion 13 and electrically connected to the first PCB board 1; and

a male connector assembly 5, which comprises a male connector housing 9 located on the second PCB board 2 and comprising male plugs 8 arranged on the male connector housing 9 and electrically connected to the second PCB board 2, wherein the male plugs 8 are engaged with the clamping portions 13;

wherein the male connector assembly 5 can be moved along with the second PCB board 2 to connect with the female connector assembly 4 in such a manner that male plugs 8 are disposed at the clamping portions 13 to enable the electrical connection between the first PCB board 1 and the second PCB board 2; and the male connector assembly 5 can be moved along with the second PCB board 2 to be separated from the female connector assembly 4 such that male plugs 8 are separated from the clamping portions 13 and the first PCB board 1 is disconnected from the second PCB board 2. In particular, the connection terminal 3 comprises the female connector assembly 4 arranged on the first PCB board 1 and the male connector assembly 5 arranged on the second PCB board 2, and the specific connection relationship between the first PCB board 1 and the second PCB board 2 is as follows.

In the case that an electrical connection between the first PCB board 1 and the second PCB board 2 is required, the second PCB board 2 can cause the male connector assembly 5 to be disposed at the female connector assembly 4 in such a manner that male plugs 8 are disposed at the clamping portions 13 to enable the electrical connection between the first PCB board 1 and the second PCB board 2. In the case that an electrical disconnection between the first PCB board 1 and the second PCB board 2 is required, the second PCB board 2 can cause the male connector assembly 5 to be separated from the female connector assembly 4 such that male plugs 8 are separated from the clamping portions 13 and the first PCB board 1 is disconnected from the second PCB board 2.

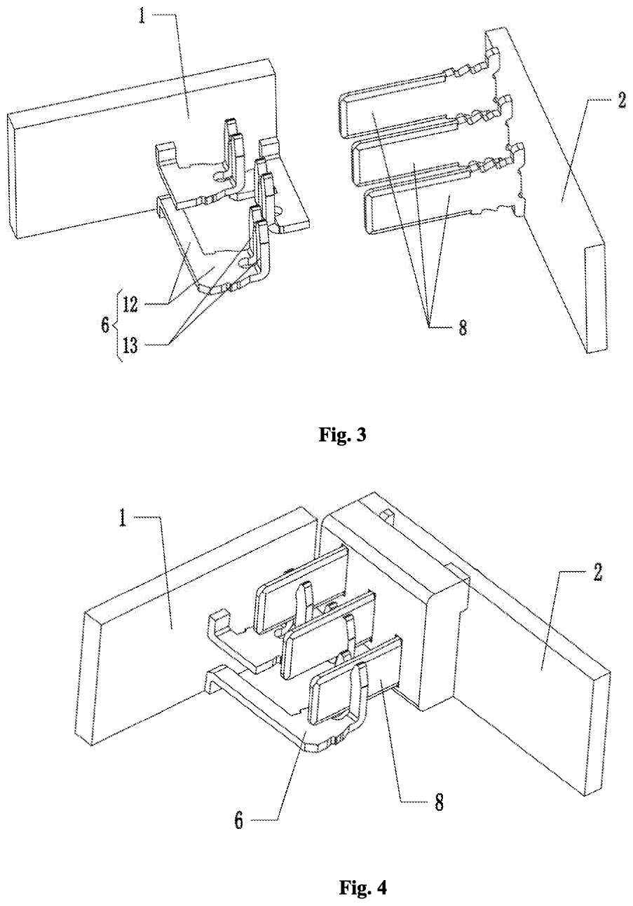

Referring to FIG. 1, the first PCB board 1 and the second PCB board 2 in the present embodiment form an angle therebetween of 90°. Referring to FIGS. 2 and 3, the female connector assembly 4 comprises three conductive clips 6, and the male connector assembly 5 comprises three male plugs 8, wherein the three male plugs 8 respectively correspond to the three conductive clips 6 in one-to-one correspondence. In particular, the three conductive clips 6 respectively correspond to the neutral wire, the live wire, and the ground wire.

Referring to FIGS. 3, 4, 5, and 6, the clamping portions 13 in the present embodiment are perpendicular to the connecting portions 12, the female connector housing 7 defines accommodating slots 11 in communication with slots 10, and the connecting portions 12 are disposed in the accommodating slots 11. In particular, the female connector housing 7 defines three accommodating slots 11, and the three conductive clips 6 are disposed at the three accommodating slots 11, respectively, wherein the connecting portions 12 are disposed in the accommodating slots 11 and the ends of the connecting portions 12 are fixed to the first PCB board 1 by welding, and the clamping portions 13 are disposed in the slots 10. The accommodating slots 11 function to support and secure the connecting portions 12.

Referring to FIGS. 2, 3, and 4, the clamping portions 13 in the present embodiment may be a pair of conductive sheets arranged in a U shape and respectively formed with a clamping protrusion. In another embodiment, the clamping portions 13 may be a pair of conductive sheets arranged in a V shape. The detailed clamping structure of the clamping portions 13 is known in the art and is not further described here.

### The Second Embodiment

A first PCB board 1 and a second PCB board 2 form an angle therebetween of 90°. The details are as follows.

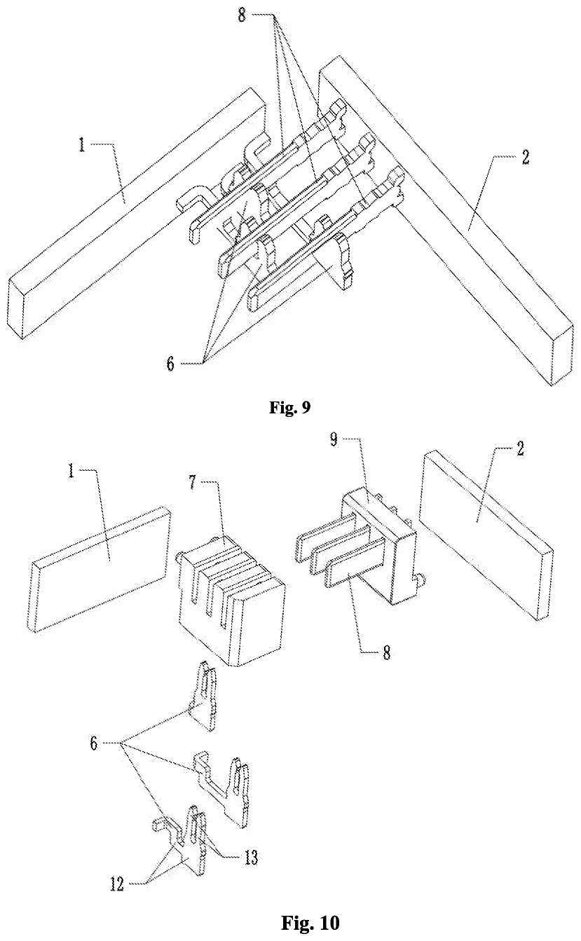

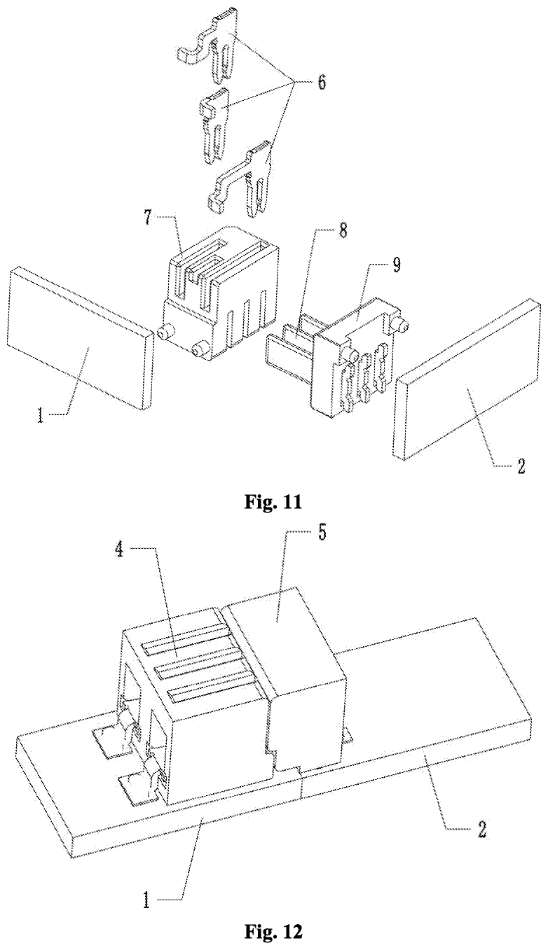

Referring to FIGS. 8-11, the clamping portions 13 in the present embodiment are parallel to the connecting portions 12, and both the clamping portions 13 and the connecting portions 12 are disposed in the slots 10. That is, the female connector housing 7 in the present embodiment is not provided with any accommodating slot 11, both the clamping portions 13 and the connecting portions 12 are disposed in the slots 10, and the ends of the connecting portions 12 are welded to the first PCB board 1.

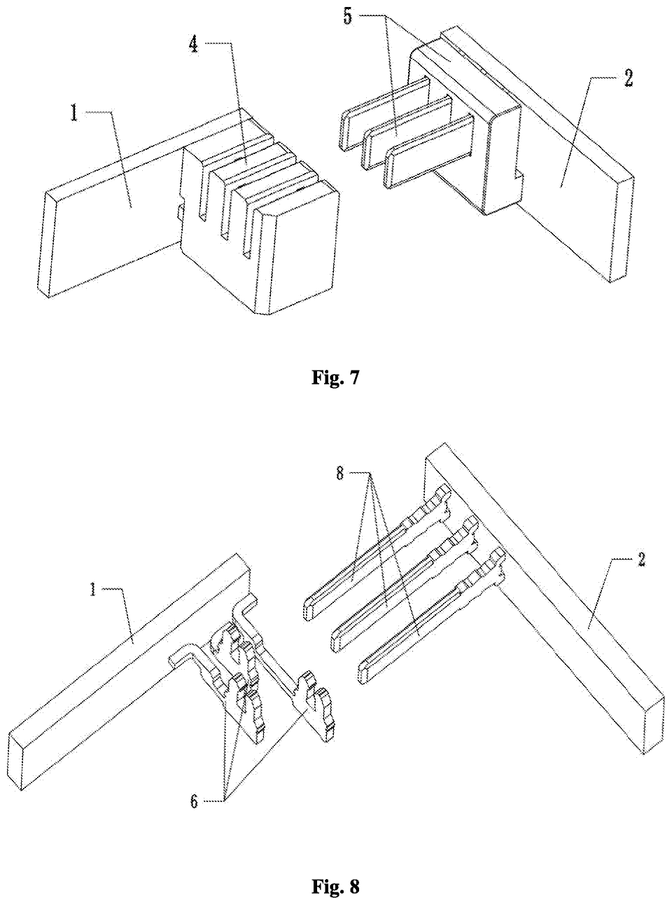

Referring to FIGS. 7, 8, and 9, the first PCB board 1 and the second PCB board 2 in the present embodiment form an angle therebetween of 90°. In the present embodiment, other structures of the female connector assembly 4 and the male connector assembly 5 are the same as those of the first embodiment and are not repeatedly described.

### The Third Embodiment

A first PCB board 1 and a second PCB board 2 form an angle therebetween of 180°. The details are as follows.

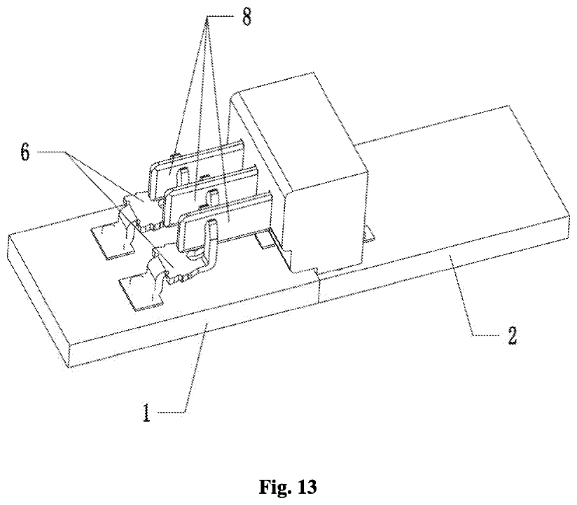

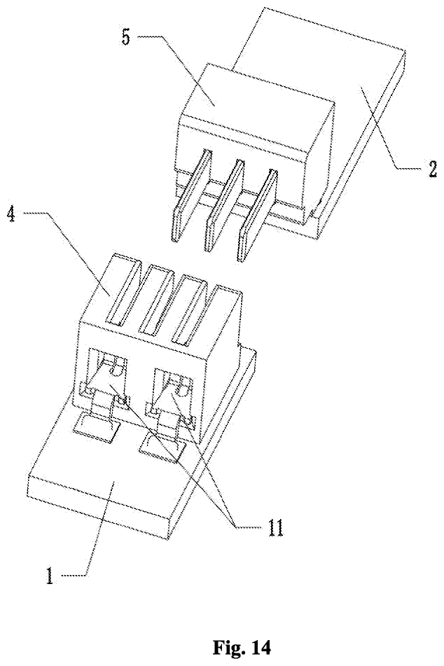

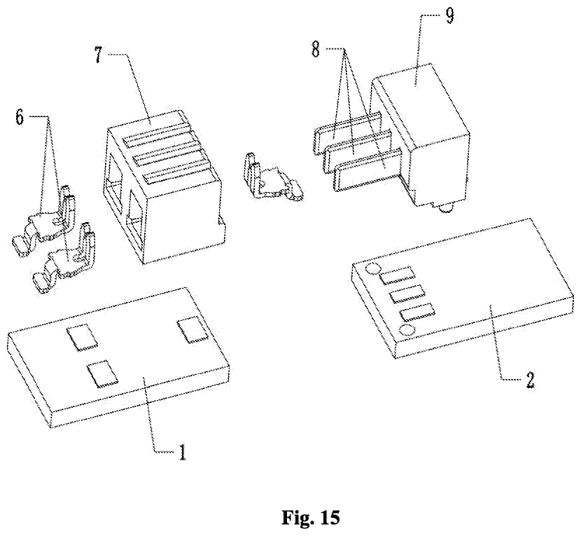

Referring to FIGS. 12-15, the first PCB board 1 and the second PCB board 2 in the present embodiment form an angle therebetween of 180°. In particular, the female connector assembly 4 is arranged on the first PCB board 1 and the male connector assembly 5 is arranged on the second PCB board 2. The second PCB board 2 can bring the male connector assembly 5 into a separable electrical connection with the female connector assembly 4 arranged on the first PCB board 1.

In the present embodiment, the structures of the female connector assembly 4 and the male connector assembly 5 are the same as those of the first embodiment and are not repeatedly described.

### The Fourth Embodiment

A first PCB board 1 and a second PCB board 2 form an angle therebetween of 180°. The details are as follows.

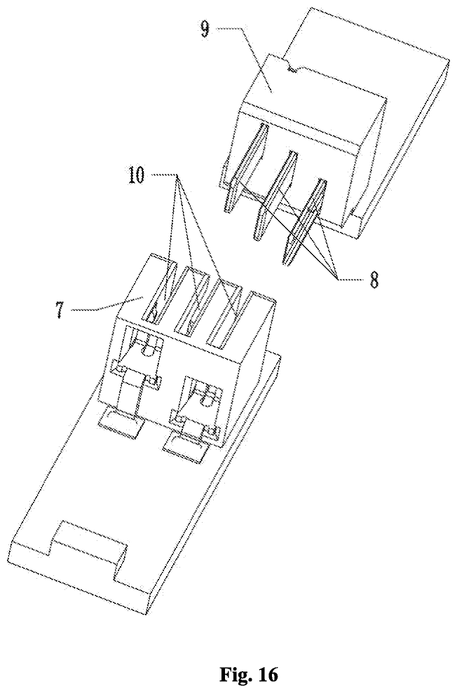

Referring to FIG. 16, the first PCB board 1 and the second PCB board 2 in the present embodiment form an angle therebetween of 180°. The female connector assembly 4 comprises three conductive clips 6, and the male connector assembly 5 comprises three male plugs 8 which respectively correspond to the three conductive clips 6 in one-to-one correspondences. In the present embodiment, the three male plugs 8 are respectively arranged on the male connector housing 9 at increasing heights corresponding to the positions of the three conductive clips 6.

In particular, to dispose the male connector assembly 5 at the female connector assembly 4 during using, the three male plugs 8 may be sequentially plugged into the three conductive clips 6 in turn. The difficulty in the plugging of male plugs 8 into conductive clips 6 in the case that the three male plugs 8 are simultaneously plugged into the three conductive clips 6 is solved.

In the present embodiment, the structures of the female connector assembly 4 and the male connector assembly 5 are the same as those of the first embodiment and are not repeatedly described.

As described in the above embodiments, two PCB boards can be electrically and separably connected by means of the connection terminal 3 of the present disclosure. Meanwhile, the connection terminal 3 further functions to retain the first PCB board 1 and the second PCB board 2, to facilitate the arrangement of the first PCB board 1 and the second PCB board 2 forming a desired angle there-between. Moreover, the connection terminal 3 of the present disclosure can provide a quick electrical connection between the first PCB board 1 and the second PCB board 2 and is convenient to operate.

In another embodiment, the first PCB board 1 and the second PCB board 2 may form an angle therebetween of 0°-180°, and in particular, the female connector assembly 4 may be obliquely arranged on the first PCB board 1, or the male connector assembly 5 may be obliquely arranged on the second PCB board 2, which will not be detailed here.

All the above are merely preferred embodiments of the present disclosure and are not intended to limit the present disclosure. Those skilled in the art may change or modify the present disclosure. The present disclosure is intended to cover all changes, equivalent arrangements and modifications included within the spirit and principle of the present disclosure.

### Numerical References

First PCB board 1,
Second PCB board 2,
Connection terminal 3,
Female connector assembly 4,
Male connector assembly 5,
Conductive clips 6,
Female connector housing 7,
Male plugs 8,
Male connector housing 9,
Slots 10,
Accommodating slots 11,
Connecting portions 12,
Clamping portions 13.

What is claimed is:

1. A connection terminal for PCB boards configured to electrically connect a first PCB board with a second PCB board, wherein the connection terminal comprises:
a female connector assembly comprising:
a female connector housing defining a slot and comprising a conductive clip located at the female connector housing and supported at the first PCB board; wherein the conductive clip comprises a clamping portion accommodated in the slot and comprises a connecting portion located on the clamping portion and electrically connected to the first PCB board; and
a male connector assembly comprising a male connector housing located on the second PCB board and comprising a male plug arranged on the male connector housing and electrically connected to the second PCB board, wherein the male plug can be engaged with the clamping portion;
wherein the male connector assembly can be moved along with the second PCB board to connect with the female connector assembly in such a manner that the male plug is disposed at the clamping portion to enable an electrical connection between the first PCB board and the second PCB board; and the male connector assembly can be moved along with the second PCB board to be separated from the female connector assembly such that the male plug is separated from the clamping portion and the first PCB board is disconnected from the second PCB board; the female connector assembly comprises a plurality of conductive clips, and the male connector assembly comprises a plurality of male plugs which respectively correspond to the plurality of conductive clips; and the plurality of male plugs are respectively arranged on the male connector housing at increasing or decreasing heights corresponding to positions of the plurality of conductive clips.

2. The connection terminal for PCB boards according to claim 1, wherein the clamping portion is perpendicular to the connecting portion, the female connector housing defines an accommodating slot in communication with the slot, and the connecting portion is disposed in the accommodating slot.

3. The connection terminal for PCB boards according to claim 1, wherein the clamping portion is parallel to the connecting portion, and both the clamping portion and the connecting portion are disposed in the slot.

4. (canceled)

5. The connection terminal for PCB boards according to claim 1, wherein the clamping portion is formed by a pair of conductive sheets arranged in a ‘U’ shape or ‘V’ shape.

6. (canceled)

7. The connection terminal for PCB boards according to claim 1, wherein the first PCB board and the second PCB board form an angle of 90° or 180°.

8. The connection terminal for PCB boards according to claim 1, wherein the female connector assembly comprises three conductive clips, and the male connector assembly comprises three male plugs which respectively correspond to the three conductive clips.

9. The connection terminal for PCB boards according to claim 1, wherein the female connector assembly comprises three conductive clips, and the male connector assembly comprises three male plugs which respectively correspond to the three conductive clips.
